(19) United States
(12) Patent Application Publication
(10) Pub. No.: US 2005/0147001 A1
(43) Pub. Date: Jul. 7, 2005

(54) Method or recording information, computer program, computer readable storage medium, and optical disk apparatus that stably record information on optical disk with high recording quality

(76) Inventor: Naoto Takahashi, Tokyo (JP)

Correspondence Address: DICKSTEIN SHAPIRO MORIN & OSHINSKY LLP, 2101 L Street, NW, Washington, DC, 20037, US

(21) Appl. No.: 11/022,679

(22) Filed: Dec. 28, 2004

(30) Foreign Application Priority Data
Jan. 5, 2004 (JP) 2004-000063

(51) Int. Cl. G11B 7/00

(52) U.S. Cl. 369/47.5; 369/116

(57) ABSTRACT

In an optical disk apparatus that records information by emitting a laser light beam from a light source to an optical disk which includes a recording area having a first zone on which information is recorded with a first optimum recording power of a laser light beam at a first recording speed and a second zone on which information is recorded with a second optimum recording power of a laser light beam at a second recording speed, a determining mechanism determines whether the first optimum recording power is adequate for use in recording information on a this time recording area provided in the first zone based on the first and second recording speeds when a last recording area is provided in the second zone. When the first optimum recording power is determined to be not adequate, a recording power obtaining mechanism obtains the updated first optimum recording power.

### CROSS-REFERENCE TO RELATED APPLICATIONS

This application claims priority to Japanese Patent Application No. 2004-000063 filed in the Japanese Patent Office on Jan. 5, 2004, the entire contents of which is hereby incorporated herein by reference.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention

The present invention relates to a method of recording information, a computer program, a computer readable storage medium, and an optical disk apparatus. Particularly, the present invention relates to a method of recording information by emitting a laser light beam from a light source to an optical disk, a computer program implemented in an optical disk apparatus, a computer readable storage medium storing such a computer program, and an optical disk apparatus that records information on an optical disk by emitting a laser light beam from a light source to the optical disk.

2. Discussion of the Related Art

Due to progress in digital technology and improvement in data compression technology in recent years, optical disks such as CDs (Compact Disc), and DVDs (Digital Versatile Disc) have gained attention for use as recording media that record information, such as music, photograph, and computer software. Further, as the costs for such optical disks become lower, an optical disk apparatus has become widely used as an information recording apparatus that records information on an optical disk. The optical disk apparatus records and erases information by irradiating a fine spot of a laser light beam to spiral or concentric tracks formed on a recording surface of an optical disk, and reproduces information according to the laser light beam reflected from the recording surface.

In order to carry out these steps, the optical disk apparatus includes an optical pickup unit for emitting laser light beams and for receiving laser light beams reflected back from the surface of the optical disk. The optical pickup unit includes several components such as an objective lens, an optics system for guiding laser light beams emitted from a light source to the surface of an optical disk and return beams to a predetermined receiving location, and a light detecting element placed at the receiving location.

Information is recorded on an optical disk according to the lengths and combination of marked areas (pits) and unmarked areas (space), which have different reflectivities. When recording information on an optical disk, the light-emitting power of a laser light beam emitted from a light source is controlled so that marked areas and space areas may be formed at a predetermined position and thus with a predetermined length. The light-emitting power of a laser light beam emitted from a light source when forming marked areas is called a “recording power”.

There are two types of systems for controlling a rotation of an optical disk when recording information on an optical disk: (1) a CLV (Constant Linear Velocity) system in which a linear velocity of a track relative to an objective lens is constant; and (2) a CAV (Constant Angular Velocity) system in which a rotational speed (angular velocity) of an optical disk is constant.

In the CAV system, because a rotational speed of an optical disk is constant, the rotation control of an optical disk at the time of recording is simple. However, as a write position is closer to an outer periphery of an optical disk, information needs to be recorded in a shorter period of time. Accordingly, a light-emitting power necessary for forming mark areas increases as a write position is closer to an outer periphery of an optical disk. Thus, circuitry and methods for controlling a light-emitting power become complex. Further, as a frequency of a write signal changes according to a write position, circuitry and methods for generating write pulses become complex.

In contrast, according to the CLV system, the linear velocity of a track is constant irrespective of a position of an objective lens in a radial direction of an optical disk. Therefore, a rotational speed of an optical disk when recording information on an inner periphery side of an optical disk is higher than that when recording information on an outer periphery side of the optical disk. Thus, the load of a disk rotation control system when recording information on an inner periphery side of an optical disk increases, so that the degradation of recording quality and the acceleration of deterioration of the disk rotation control system may typically occur.

Further, an optical disk apparatus in which the rotation of an optical disk is controlled by using a zone constant linear velocity (ZCLV) system is proposed. In the ZCLV system, a recording area of an optical disk is divided into a plurality of zones, and a linear velocity is maintained constant within each of the zones. For example, such an optical disk apparatus is described in Japanese Laid-Open Patent Applications No. 2002-358642 and No. 2003-123256.

Generally, in an optical disk apparatus, before recording information on an optical disk, a so-called optimum power control (OPC) is performed to determine an optimum recording power of a laser light beam at a desired linear velocity, that is, at a desired recording speed. The optimum recording power determined in an OPC operation is stored in connection with a recording speed. When recording information by using the ZCLV system, information is recorded at the same linear velocity within each of zones. So, when recording information in a zone in which an optimum recording power has been already obtained, the information is recorded with the already obtained optimum recording power without performing an OPC operation. By doing so, recording performance is enhanced.

Generally, when recording information on an optical disk, the information is recorded continuously from the inner periphery side to the outer periphery side of the optical disk. For example, when recording information on a DVD+R disk, a write area can be reserved. After recording information on an area located on an outer periphery side of the DVD+R disk relative to a reserved area, information is allowed to be recorded on the reserved area. For example, assuming that an optical disk includes a first zone in which a linear velocity S1 is set and a second zone in which a linear velocity S2 greater than the linear velocity S1 is set and a part of the first zone is reserved, after recording information on the first zone excluding a reserved area and on the second zone successively, information is recorded on the reserved area in the first zone with an optimum recording power which has been already obtained at the linear velocity S1. However, a light-emitting characteristic of a light source varies depending on a use condition of the light source. Accordingly, the light-emitting characteristic of the light source after the information is recorded on the second zone at the linear velocity S2 may be different from the light-emitting characteristic of the light source when performing an OPC operation at the linear velocity S1. Particularly, the optimum recording power already obtained at the linear velocity S1 may not be equal to an optimum recording power used for recording information on the reserved area in the first zone. Consequently, a recording quality at the reserved area may be degraded.

Therefore, it is desirable to provide a method of recording information and an optical disk apparatus that can stably record information on an optical disk with high recording quality.

Further, it is desirable to provide a computer program implemented in the optical disk apparatus and a computer readable storage medium storing such a computer program that can stably record information on an optical disk with high recording quality.

### BRIEF SUMMARY OF THE INVENTION

According to an aspect of the present invention, a method of recording information by emitting a laser light beam from a light source to an optical disk which includes a recording area divided into a plurality of zones where information is recorded at predetermined recording speeds, respectively, the plurality of zones including a first zone on which information is recorded with a predetermined recording power of a laser light beam at a recording speed set corresponding to the first zone, and a second zone on which information is recorded with a predetermined recording power of a laser light beam at a recording speed set corresponding to the second zone, includes steps of obtaining an optimum recording power of a laser light beam emitted when recording information on the first zone at the recording speed set corresponding to the first zone, obtaining an optimum recording power of a laser light beam emitted when recording information on the second zone at the recording speed set corresponding to the second zone, determining whether the optimum recording power of the laser light beam emitted when recording information on the first zone is adequate for use in recording information on a this time recording area provided in the first zone based on the recording speed set corresponding to the first zone and the recording speed set corresponding to the second zone when a last recording area is provided in the second zone, and obtaining updated optimum recording power of the laser light beam emitted when recording information on the first zone when the optimum recording power of the laser light beam emitted when recording information on the first zone is determined to be not adequate.

According to another aspect of the present invention, a computer program includes program code means that, when executed by a controller of an optical disk apparatus, instructs the apparatus to carry out a method of recording information by emitting a laser light beam from a light source to an optical disk which includes a recording area divided into a plurality of zones where information is recorded at predetermined recording speeds, respectively, the plurality of zones including a first zone on which information is recorded with a predetermined recording power of a laser light beam at a recording speed set corresponding to the first zone, and a second zone on which information is recorded with a predetermined recording power of a laser light beam at a recording speed set corresponding to the second zone, the method including steps of obtaining an optimum recording power of a laser light beam emitted when recording information on the first zone at the recording speed set corresponding to the first zone, obtaining an optimum recording power of a laser light beam emitted when recording information on the second zone at the recording speed set corresponding to the second zone, determining whether the optimum recording power of the laser light beam emitted when recording information on the first zone is adequate for use in recording information on a this time recording area provided in the first zone based on the recording speed set corresponding to the first zone and the recording speed set corresponding to the second zone when a last recording area is provided in the second zone, and obtaining updated optimum recording power of the laser light beam emitted when recording information on the first zone when the optimum recording power of the laser light beam emitted when recording information on the first zone is determined to be not adequate.

According to another aspect of the present invention, a computer readable storage medium stores the above-described computer program.

According to yet another aspect of the present invention, an optical disk apparatus that performs at least an information recording operation among the information recording operation, an information reproducing operation, and an information erasing operation, includes a light source configured to emit a laser light beam to an optical disk which includes a recording area divided into a plurality of zones where information is recorded at predetermined recording speeds, respectively, wherein the plurality of zones include a first zone on which information is recorded with a predetermined recording power of a laser light beam at a recording speed set corresponding to the first zone, and a second zone on which information is recorded with a predetermined recording power of a laser light beam at a recording speed set corresponding to the second zone, a recording power obtaining mechanism configured to obtain an optimum recording power of a laser light beam emitted when recording information on the first zone at the recording speed set corresponding to the first zone, and to obtain an optimum recording power of a laser light beam emitted when recording information on the second zone at the recording speed set corresponding to the second zone, a determining mechanism configured to determine whether the optimum recording power of the laser light beam emitted when recording information on the first zone, which has been obtained by the recording power obtaining mechanism, is adequate for use in recording information on a this time recording area provided in the first zone based on the recording speed set corresponding to the first zone and the recording speed set corresponding to the second zone when a last recording area is provided in the second zone, wherein when the determining mechanism determines that the optimum recording power of the laser light beam emitted when recording information on the first zone is not adequate, the recording power obtaining mechanism is configured to obtain updated optimum recording power of the laser light beam emitted when recording information on the first zone, and a recording mechanism configured to record information on the first zone with the updated optimum recording power obtained by the recording power obtaining mechanism.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of a configuration of an optical disk apparatus according to an embodiment of the present invention;

FIG. 2 is a schematic diagram of an optical pickup device shown in FIG. 1;

FIGS. 3A and 3B are flowcharts of recording process control operation steps of a CPU according to an embodiment of the present invention;

FIG. 4 is an illustration for explaining a relationship between a zone and a recording speed;

FIG. 5 is an illustration for explaining various types of storage areas provided in a RAM shown in FIG. 1;

FIGS. 6A, 6B, and 6C are illustrations for explaining recording areas;

FIG. 7 is a schematic diagram of the optical pickup device of FIG. 2 including a temperature sensor; and

FIGS. 8A, 8B, and 8C are flowcharts of recording process control operation steps of the CPU according to another embodiment of the present invention.

### DETAILED DESCRIPTION OF THE INVENTION

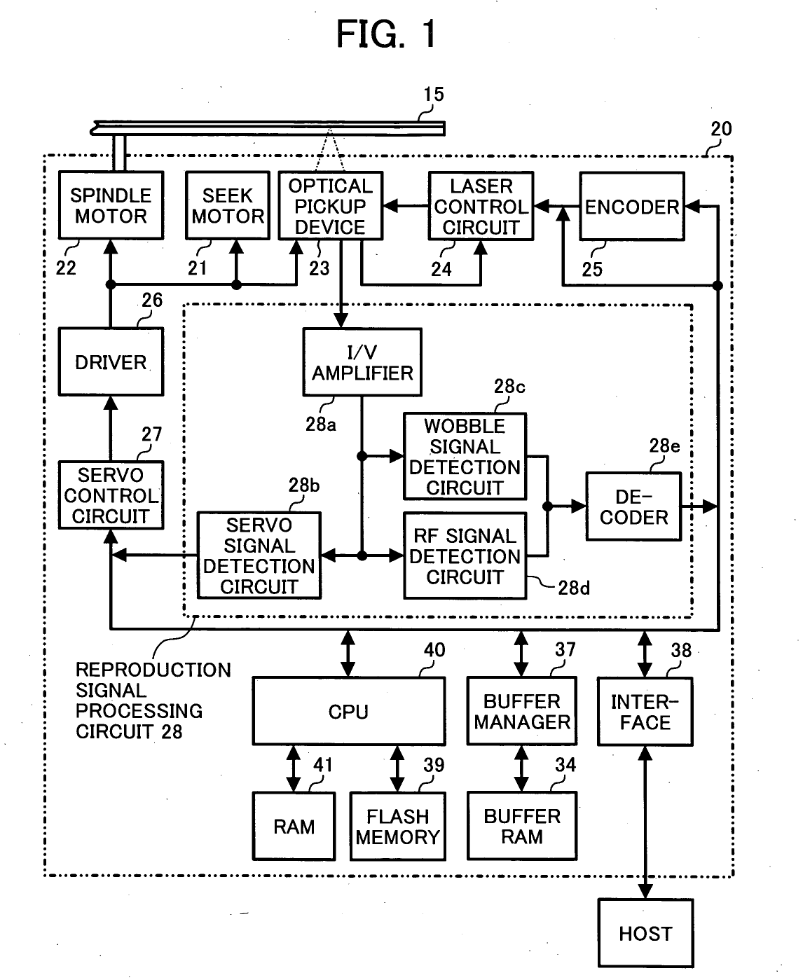

Preferred embodiments of the present invention are described in detail referring to FIGS. 1 through 10, wherein like reference numerals designate identical or corresponding parts throughout the several views.

FIG. 1 is a block diagram of a configuration of an optical disk apparatus 20 according to an embodiment of the present invention.

The optical disk apparatus 20 shown in FIG. 1 includes a seek motor 21, a spindle motor 22, an optical pickup device 23, a laser control circuit 24, an encoder 25, a driver 26, a servo control circuit 27, a reproduction signal processing circuit 28, a/ buffer RAM 34, a buffer manager 37, an interface 38, a flash memory 39, a CPU 40, and a RAM 41. It is noted that the arrows and connection lines indicated in FIG. 1 are merely representative lines for illustrating the overall flow of signals and information and do not represent the entire connection relation between the blocks. According to the present embodiment, the optical disk apparatus 20 may be compatible with an information recording medium, such as an optical disk 15, conforming to a DVD+R standard.

The seek motor 21 drives the optical pickup device 23 to move in a sledge direction. The spindle motor 22 drives the optical disk 15 to rotate.

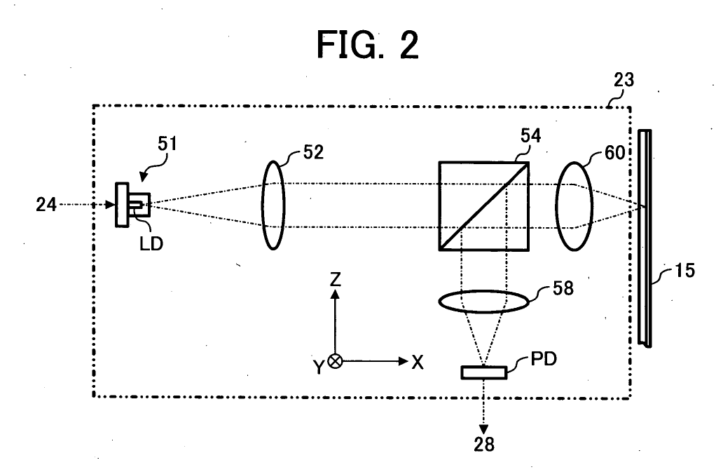

The optical pickup device 23 is configured to irradiate a laser light beam onto a recording surface of the optical disk 15 on which spiral or concentric tracks (i.e., recording areas) are formed, and to receive reflected light from the recording surface. As illustrated in FIG. 2, the optical pickup device 23 includes a light source unit 51, a collimator lens 52, a beam splitter 54, an objective lens 60, a detection lens 58, a photo detector PD, and a drive system, such as a focusing actuator (not shown), and a tracking actuator (not shown).

The light source unit 51 includes a semiconductor laser LD functioning as a light source that emits a laser light beam with a wavelength of about 660 nm. In the present embodiment, a maximum intensity emission direction of a laser light beam emitted from the light source unit 51 is set to the +X direction in FIG. 2. The collimator lens 52 is placed at the +X direction side of the light source unit 51, and collimates the laser light beam emitted from the light source unit 51.

The beam splitter 54 is placed at the +X direction side of the collimator lens 52, and allows the laser light beam collimated by the collimator lens 52 to pass through the beam splitter 54. Further, the beam splitter 54 diverts the laser light beam, which has been reflected from the recording surface of the optical disk 15 and has been incident via the objective lens 60, in the −Z direction. The objective lens 60 is placed at the +X direction side of the beam splitter 54 and condenses the laser light beam passing through the beam splitter 54 so that a laser spot is formed on the recording surface of the optical disk 15.

The detection lens 58 is placed at the −Z direction side of the beam splitter 54 and condenses the reflected light diverted by the beam splitter 54 onto a light receiving surface of the photo detector PD. As similarly in a conventional optical pickup device, the photo detector PD is formed from a plurality of photoreceptors that output a plurality of signals including, for example, wobble signal information, reproduction data information, focus error information, and track error information. Each of the photoreceptors generates a current signal according to the amount of received light by carrying out a photoelectric transformation, and outputs the current signal to the reproduction signal processing circuit 28.

The focusing actuator (not shown) slightly drives the objective lens 60 in a focus direction (i.e., in “X” direction in FIG. 2) which is equal to an optical axis direction of the objective lens 60. The tracking actuator (not shown) slightly drives the objective lens 60 in a tracking direction (i.e., in “Z” direction in FIG. 2) which is orthogonal to a tangential direction of the tracks.

Referring back to FIG. 1, the reproduction signal processing circuit 28 includes an I/V amplifier 28a, a servo signal detection circuit 28b, a wobble signal detection circuit 28c, an RF signal detection circuit 28d, and a decoder 28e.

The I/V amplifier 28a converts a current signal corresponding to an output signal of the photo detector PD into a voltage signal. The voltage signal is amplified with a predetermined gain. The servo signal detection circuit 28b detects a servo signal such as a focus error signal, and track error signal, from the output signal of the I/V amplifier 28a. The servo signal detected herein is output to the servo control circuit 27.

The wobble signal detection circuit 28c detects a wobble signal from the output signal of the I/V amplifier 28a. The RF signal detection circuit 28d detects an RF signal from the output signal of the I/V amplifier 28a.

The decoder 28e extracts data, such as address information, and a synchronization signal, from the wobble signal detected by the wobble signal detection circuit 28c. The extracted address information is output to the CPU 40, and the synchronization signal is output to the encoder 25. The decoder 28e performs processes, such as demodulation and error correction processes, on the RF signal detected by the RF signal detection circuit 28d, and stores the resulting data as reproduction data in the buffer RAM 34 via the buffer manager 37.

The servo control circuit 27 generates a focus control signal for correcting a focus deviation based on the focus error signal from the servo signal detection circuit 28b, and generates a tracking control signal for correcting a track deviation based on the track error signal from the servo signal detection circuit 28b. Further, the servo control circuit 27 generates a spindle motor control signal for controlling the drive of the spindle motor 22 based on an instruction from the CPU 40. Moreover, the servo control circuit 27 generates a seek motor control signal for controlling the drive of the seek motor 21 based on an instruction from the CPU 40. The above-described control signals generated by the servo control circuit 27 are output to the driver 26.

The driver 26 outputs a drive signal for driving the focusing actuator corresponding to the focus control signal to the optical pickup device 23, and outputs a drive signal for driving the tracking actuator corresponding to the tracking control signal to the optical pickup device 23. Thereby, tracking control and focus control are performed. Further, the driver 26 outputs a drive signal corresponding to the above-described spindle motor control signal to the spindle motor 22, and outputs a drive signal corresponding to the above-described seek motor control signal to the seek motor 21.

The buffer RAM 34 includes a buffer area and a variable area. The buffer area temporarily stores data to be recorded on the optical disk 15 and data reproduced from the optical disk 15. The variable area stores variables of various types of programs. The buffer manager 37 manages input and output data to/from the buffer RAM 34.

The encoder 25 extracts data to be recorded which is stored in the buffer RAM 34 via the buffer manager 37 based on an instruction from the CPU 40, performs processes, such as data demodulation and attachment of an error correction code, and generates a write signal to be written on the optical disk 15. The write signal generated by the encoder 25 is output to the laser control circuit 24.

The laser control circuit 24 controls the power of a laser light beam emitted from the semiconductor laser LD onto the optical disk 15. When recording data on the optical disk 15, a drive signal for the semiconductor laser LD is generated based on recording conditions, the light-emitting characteristic of the semiconductor laser LD, and the write signal from the encoder 25.

The interface 38 corresponds to a bidirectional communication interface with a host such as a personal computer, and may be a standard interface conforming to AT Attachment Packet Interface (ATAPI) and Small Computer System Interface (SCSI), for example.

The flash memory 39 includes a program area and a data area. The program area stores a program which is described in code readable by the CPU 40 and is started when recording user data sent from the host onto the optical disk 15. The data area stores information, such as the light-emitting characteristic of the semiconductor laser LD, and recording conditions including zone information (described below).

The CPU 40 controls operations in each of the blocks according to the program stored in the program area of the flash memory 39, and stores data necessary for controlling the blocks in the variable area of the buffer RAM 34 and in the RAM 41. Further, a timer (not shown) is attached to the CPU 40. The CPU 40 is configured to reset a count value of the timer, start the counting-up of the timer, stop the counting-up of the timer, and read a count value of the timer. The timer may be a software timer that counts up by the interrupt of the CPU 40. Hereafter, the count value of the timer may be referred to as a “timer value” of the timer.

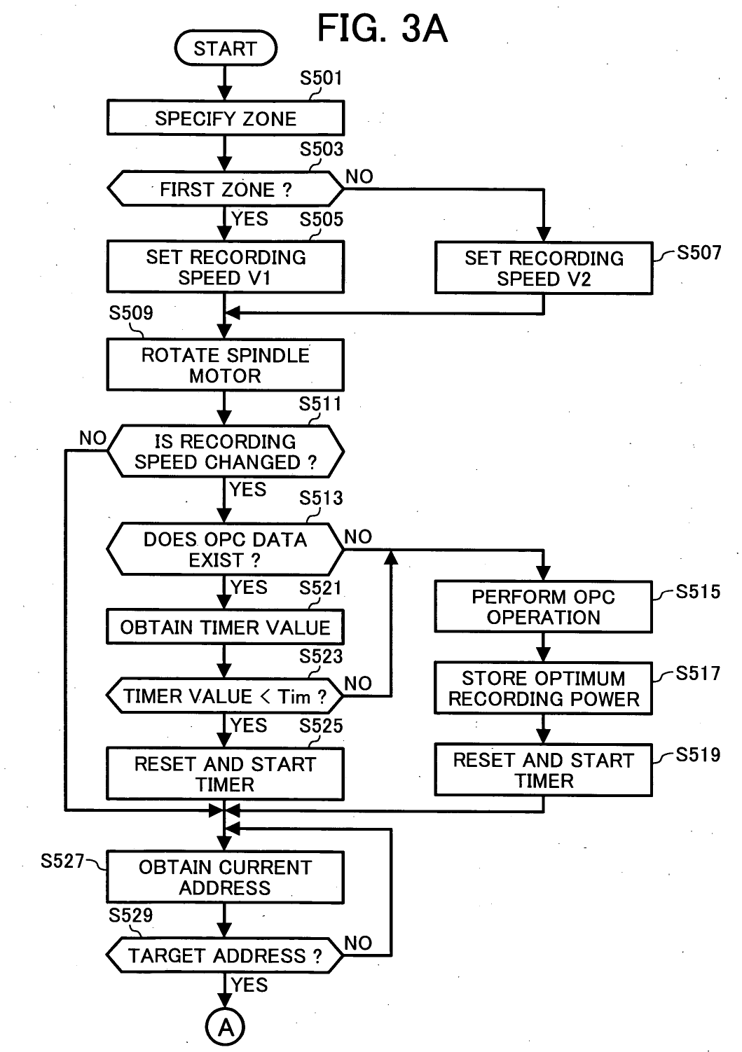

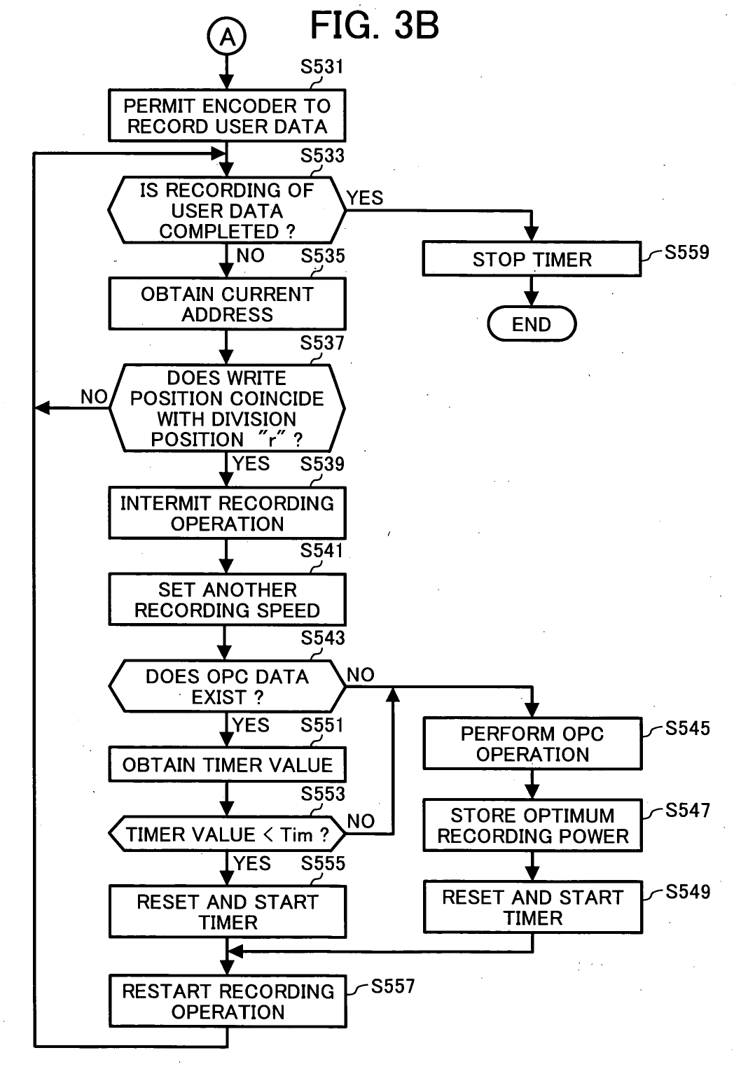

FIGS. 3A and 3B are flowcharts of recording process control operation steps of the CPU 40 according to an embodiment of the present invention. The recording process control operation steps shown in these flowcharts correspond to a sequence of process algorithms of a recording process program executed by the CPU 40. Upon receiving a recording request command from the host, a leading address of the recording process program corresponding to the flowcharts of FIGS. 3A and 3B is set to a program counter of the CPU 40, and the recording process control operation starts. In this embodiment, it is assumed that the optical disk 15 is a blank disk.

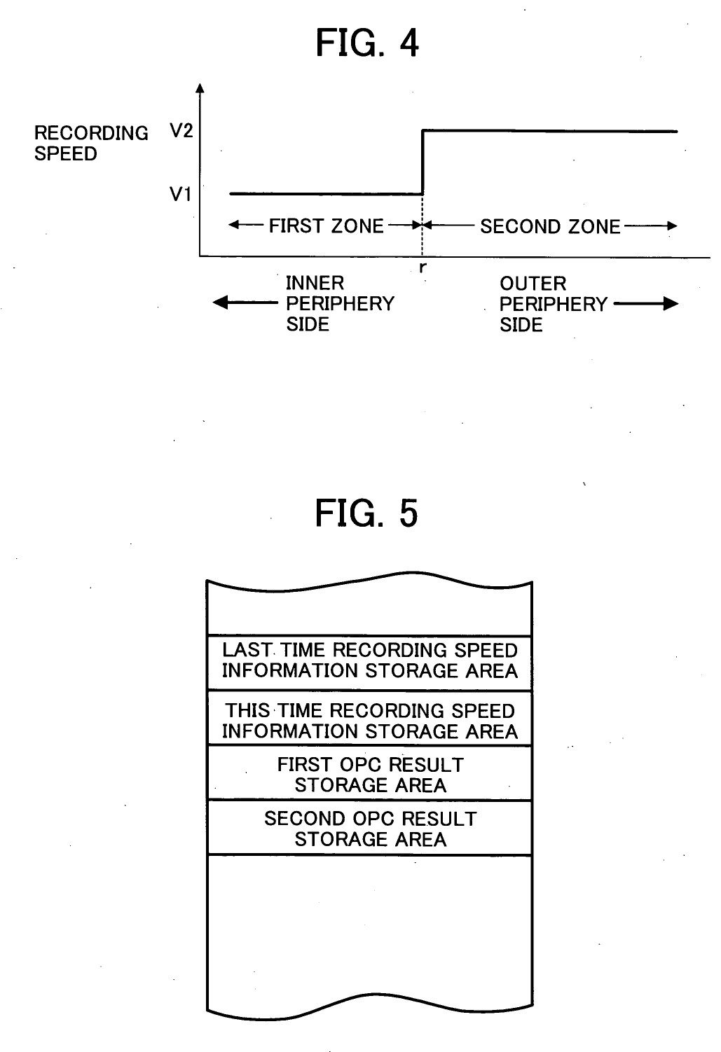

Further, in this embodiment, a zone constant linear velocity (ZCLV) system is used for controlling the rotation of the optical disk 15 when recording information on the optical disk 15. As a non-limiting example, as shown in FIG. 4, the track of the optical disk 15 is divided into two zones, that is, a first zone and a second zone. The first zone is located at the inner periphery side of the optical disk 15 relative to a position “r” (hereafter referred to as a division position “r”) located at a predetermined distance away from the rotation center of the optical disk 15. The second zone is located at the outer periphery side of the optical disk 15 relative to the division position “r”. In the first zone, information is recorded at a recording speed V1. In the second zone, information is recorded at a recording speed V2 greater than the recording speed V1. The information with respect to the division position “r” and the recording speeds V1 and V2 is stored in the data area of the flash memory 39 as the zone information.

Further, as a non-limiting example, as shown in FIG. 5, the RAM 41 includes a last time recording speed information storage area, a this time recording speed information storage area, a first OPC result storage area, and a second OPC result storage area. In the last time recording speed information storage area, the information of recording speed at the last recording is stored. In the this time recording speed information storage area, the information of recording speed at this time recording is stored. In the first OPC result storage area, an optimum recording power obtained in an OPC operation when recording at the recording speed V1 is stored as OPC data. In the second OPC result storage area, an optimum recording power obtained in an OPC operation when recording at the recording speed V2 is stored as OPC data. The above-described respective storage areas are reset or cleared by being written with dummy data when the optical disk 15 is loaded into the optical disk apparatus 20.

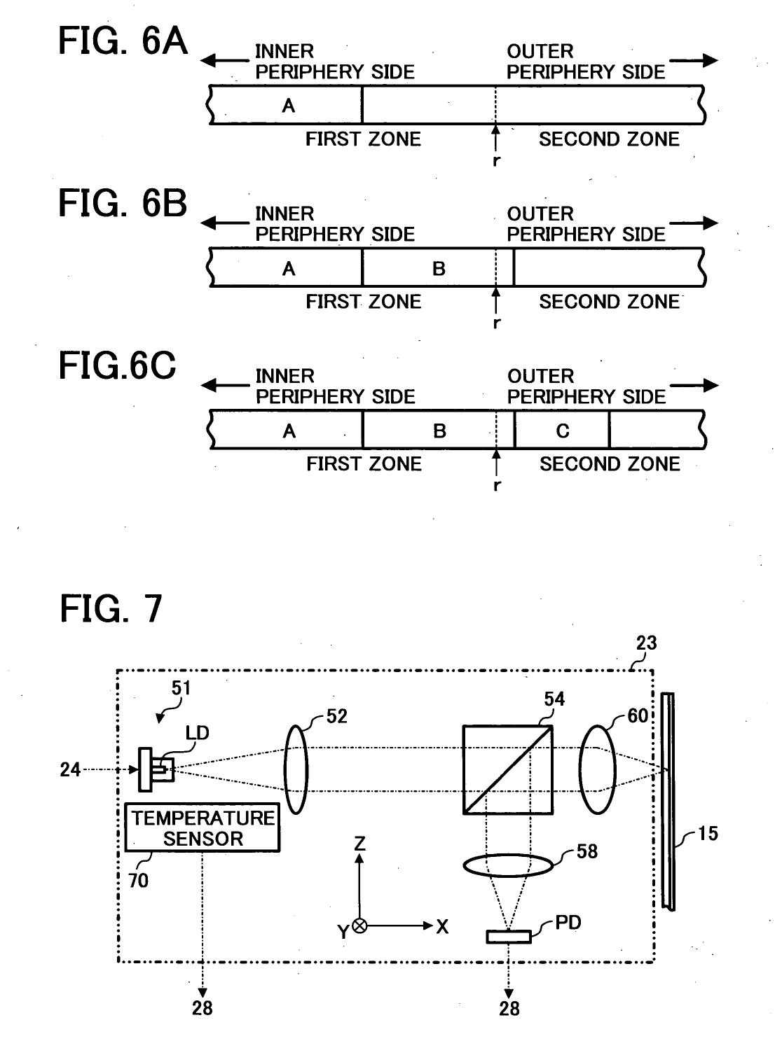

First, according to an embodiment of the present invention, the recording process control operation is performed when recording user data on an area A provided in the first zone of the optical disk 15 of FIG. 6A as described below.

In step S501 of FIG. 3A, the CPU 40 extracts a leading address attached to the recording request command and a data length, and specifies a zone in which an area to be recorded with user data is provided by referring to the zone information. Further, the CPU 40 instructs the buffer manager 37 to store data to be recorded on the area A of the optical disk 15, which is received from the host, in the buffer area of the buffer RAM 34.

Next, the CPU 40 determines whether the specified zone is the first zone in step S503. In this embodiment, as user data is recorded on the area A provided in the first zone, the answer in step S503 becomes YES. Then, the CPU 40 sets the recording speed V1 as a recording speed in step S505. The information with respect to the recording speed set in step S505 (hereafter referred to as a “set recording speed”) is stored in the this time recording speed information storage area of the RAM 41. The information with respect to the set recording speed may be information which can be converted to the set recording speed or information such as a flag, which can specify or differentiate the set recording speed, other than the set recording speed itself.

Next, in step S509, the CPU 40 instructs the servo control circuit 27 to rotate the spindle motor 22 at the set recording speed (i.e., the recording speed V1). In addition, the CPU 40 notifies the reproduction signal processing circuit 28 of the receipt of the recording request command from the host. Further, the CPU 40 sets the servo-on onto the servo control circuit 27 when the CPU 40 confirms that the rotational speed of the spindle motor 22 reaches the set recording speed, and thereby tracking and focusing controls are performed as described above. The tracking and focusing controls are performed at any desired time until the recording process control operation is completed.

Subsequently, in step S511, the CPU 40 compares the this time recording speed information storage area to the last time recording speed information storage area, and determines whether the recording speed is changed. Because this is the first recording process and the last time recording speed information storage area is under a reset condition, the answer in step S511 becomes YES, and the recording process control operation proceeds to step S513.

Next, in step S513, the CPU 40 refers to the OPC result storage area, and determines whether OPC data obtained at the set recording speed exists. Because OPC data at the set recording speed V1 has not yet been obtained, the answer in step S513 becomes NO, and the recording process control operation proceeds to step S515.

Subsequently, in step S515, the CPU 40 performs an OPC operation at the set recording speed (i.e., the recording speed V1) and obtains an optimum recording power. Specifically, test data is recorded on a test recording area called a power calibration area (PCA) while changing recording power step by step. Subsequently, the test data recorded in the test recording area is successively reproduced. For example, if an asymmetry value detected from RF signals coincides approximately with a target value previously obtained based on experimental results, such an asymmetry value is determined to be an optimal asymmetry value representing an optimum recording quality. Then, the recording power resulting in an optimum asymmetry value is set as an optimal recording power. In this OPC operation, because the recording speed is relatively low, test data is recorded on the PCA located at the inner periphery side of the optical disk 15.

Next, in step S517, the CPU 40 stores the optimum recording power obtained in the OPC operation in step S515 as OPC data in the first OPC result storage area of the RAM 41. Then, in step S519, after a timer value of a timer is reset to “0”, the CPU 40 starts the timer.

Subsequently, in step S527, the CPU 40 obtains a current address based on the address information from the decoder 28e. Next, in step S529, the CPU 40 determines whether the current address coincides with a target address. If the answer is NO in step S529, the CPU 40 calculates an address difference between the current address and the target address. If the calculated address difference is relatively great and the CPU 40 determines that seek movements are necessary, the CPU 40 instructs the servo control circuit 27 to drive the seek motor 21 according to the calculated address difference. Thereby, the seek motor 21 is driven, and seek movements are performed such that the address difference decreases. Subsequently, the recording process control operation returns to reexecute step S527. Until the current address coincides with the target address, the loop process of steps S527 and S529 is repeated.

If the current address coincides with the target address (i.e., the answer is YES in step S529), the recording process control operation proceeds to step S531.

In step S531, the CPU 40 permits the encoder 25 to record user data (not test data) on the area A provided in the first zone of the optical disk 15. Specifically, the CPU 40 turns a write signal on for the encoder 25, and thereby user data is recorded on the optical disk 15 by way of the encoder 25, the laser control circuit 24, and the optical pickup device 23. After the storage data in the this time recording speed information storage area in the RAM 41 is moved or copied to the last time recording speed storage area, the recording process control operation proceeds to step S533.

n step S533, the CPU 40 determines whether the recording of user data on the area A is completed. If the answer is NO in step S533, the recording process control operation proceeds to step S535.

In step S535, the CPU 40 obtains a current address based on the address information from the decoder 28e.

Next, in step S537, the CPU 40 refers to the zone information stored in the data area of the flash memory 39, and determines whether the write position is the division position “r” where the recording speed is changed. In this embodiment, because the entire area A is provided in the first zone, the recording speed is not changed until the recording of the user data is completed. Accordingly, the answer is NO in step S537, and the recording process control operation proceeds to step S533. Until the recording of the user data on the area A is completed, the loop process of steps S533 through S537 is repeated. That is, an OPC operation is not performed again until the recording of the user data is completed.

After the recording of the user data on the area A is completed (i.e., the answer is YES in step S533), the CPU 40 stops the timer in step S559. After the predetermined process is performed, the recording process control operation ends.

Next, a description with regard to the recording process control operation according to another embodiment of the present invention will be made of a case in which after an area B of the optical disk 15 (shown in FIG. 6B) which is adjacent to the area A is reserved, user data is recorded on an area C of the optical disk 15 (shown in FIG. 6C) which is adjacent to the area B. As shown in FIGS. 6B and 6C, the part of the area B is provided in the second zone, and the entire area C is provided in the second zone. The description of the recording process control operation of this embodiment similar to the above-described recording process control operation performed when recording user data on the area A is simplified or omitted.

Referring again to FIG. 3A, in step S501, the CPU 40 specifies a zone in which an area to be recorded with user data is provided by referring to the zone information. Next, in step S503, the CPU 40 determines whether the specified zone is the first zone. In this embodiment, as user data is recorded on the area C provided in the second zone, the answer in step S503 becomes NO, and the recording process control operation proceeds to step S507.

In step S507, the CPU 40 sets the recording speed V2 as a recording speed. The information with respect to the recording speed set in step S507 is stored in the this time recording speed information storage area of the RAM 41.

Next, in step S509, the CPU 40 instructs the servo control circuit 27 to rotate the spindle motor 22 at the set recording speed (i.e., the recording speed V2). Subsequently, in step S511, the CPU 40 compares the this time recording speed information storage area to the last time recording speed information storage area, and determines whether the recording speed is changed. Because the information with regard to the recording speed V1 is stored in the last time recording speed information storage area, the answer in step S511 becomes YES, and the recording process control operation proceeds to step S513.

Then, in step S513, the CPU 40 refers to the OPC result storage area, and determines whether OPC data obtained at the set recording speed exists. Because OPC data at the set recording speed V2 has not yet been obtained, the answer in step S513 becomes NO, and the recording process control operation proceeds to step S515.

Subsequently, in step S515, the CPU 40 performs an OPC operation at the set recording speed (i.e., the recording speed V2) and obtains an optimum recording power. In this OPC operation, because the recording speed is a relatively high, test data is recorded on the PCA located at the outer periphery side of the optical disk 15.

Next, in step S517, the CPU 40 stores the optimum recording power obtained in the OPC operation in step S515 as OPC data in the second OPC result storage area of the RAM 41. Then, in step S519, after a timer value of a timer is reset to “0”, the CPU 40 starts the timer.

Further, the recording process control operation similar to the above-described recording process control operation performed when recording user data on the area A is performed in steps S527 and S529. When the answer is YES in step S529, the recording process control operation proceeds to step S531.

In step S531, the CPU 40 permits the encoder 25 to record user data (not test data) on the area C provided in the second zone of the optical disk 15. After the storage data in the this time recording speed information storage area in the RAM 41 is moved or copied to the last time recording speed storage area, the recording process control operation proceeds to step S533.

In step S533, the CPU 40 determines whether the recording of user data on the area C is completed. If the answer is NO in step S533, the recording process control operation proceeds to step S535.

In step S535, the CPU 40 obtains a current address based on the address information from the decoder 28e.

Next, in step S537, the CPU 40 refers to the zone information stored in the data area of the flash memory 39, and determines whether the write position is the division position “r” where the recording speed is changed. In this embodiment, because the entire area C is provided in the second zone, the recording speed is not changed until the recording of the user data is completed. Accordingly, the answer is NO in step S537, and the recording process control operation proceeds to step S533. Until the recording of the user data on the area C is completed, the loop process of steps S533 through S537 is repeated. That is, an OPC operation is not performed again until the recording of the user data is completed.

After the recording of the user data on the area C is completed (i.e., the answer is YES in step S533), the CPU 40 stops the timer in step S559. At this time, the CPU 40 stores the timer value of the timer in the RAM 41. After the predetermined process is performed, the recording process control operation ends.

Next, according to another embodiment of the present invention, the recording process control operation is performed when recording user data on the reserved area B of the optical disk 15 as described below. The description of the recording process control operation of this embodiment similar to the above-described recording process control operation performed when recording user data on the area A or the area C is simplified or omitted.

Referring again to FIG. 3A, in step S501, the CPU 40 specifies a zone in which an area to be recorded with user data is provided by referring to the zone information. Next, in step S503, the CPU 40 determines whether the specified zone is the first zone. In this embodiment, as the leading portion of the area B is provided in the first zone, the answer in step S503 becomes YES, and the recording process control operation proceeds to step S505.

In step S505, the CPU 40 sets the recording speed V1 as a recording speed. The information with respect to the recording speed set in step S505 is stored in the this time recording speed information storage area of the RAM 41.

Next, in step S509, the CPU 40 instructs the servo control circuit 27 to rotate the spindle motor 22 at the set recording speed (i.e., the recording speed V1). Subsequently, in step S511, the CPU 40 compares the this time recording speed information storage area to the last time recording speed information storage area, and determines whether the recording speed is changed. Because the information with regard to the recording speed V2 is stored in the last time recording speed information storage area, the answer in step S511 becomes YES, and the recording process control operation proceeds to step S513.

Then, in step S513, the CPU 40 refers to the OPC result storage area, and determines whether OPC data obtained at the set recording speed exists. Because OPC data at the set recording speed V1 has been stored in the first OPC result storage area, the answer in step S513 becomes YES, and the recording process control operation proceeds to step S521.

Subsequently, in step S521, the CPU 40 obtains the timer value of the timer which was stored in the RAM 41 in step S559 after the recording of the user data on the area C was completed. Then, in step S523, the CPU 40 determines whether the timer value obtained in step S521 is less than a predetermined value “Tim”. For example, the predetermined value “Tim” is 30 seconds. If the timer value obtained in step S521 is less than the value “Tim”, the CPU 40 determines that the OPC data stored in the first OPC result storage area is adequate for recording user data with the optimum recording power obtained in step S515 in the recording process control operation performed when recording the user data on the area A. Then, after the timer value of the timer is reset to “0”, the CPU 40 starts the timer in step S525.

In contrast, if the timer value obtained in step S521 is greater than or equal to the value “Tim”, the CPU 40 determines that the OPC data stored in the first OPC result storage area is inadequate. Accordingly, an optimum recording power is obtained by performing an OPC operation again at the set recording speed (i.e., the recording speed V1) in step S515.

Next, in step S517, the CPU 40 stores the optimum recording power obtained in the OPC operation in step S515 as OPC data in the first OPC result storage area of the RAM 41. Thus, the OPC data stored in the first OPC result storage area of the RAM 41 is updated. Subsequently, in step S519, after the timer value of the timer is reset to “0”, the CPU 40 starts the timer.

Further, the recording process control operation similar to the above-described recording process control operation performed when recording user data on the area A is performed in steps S527 and S529. When the answer is YES in step S529, the recording process control operation proceeds to step S531.

In step S531, the CPU 40 permits the encoder 25 to record user data (not test data) on the area B provided in the first zone of the optical disk 15. After the storage data in the this time recording speed information storage area in the RAM 41 is moved or copied to the last time recording speed storage area, the recording process control operation proceeds to step S533.

In step S533, the CPU 40 determines whether the recording of user data on the area B is completed. If the answer is NO in step S533, the recording process control operation proceeds to step S535. In step S535, the CPU 40 obtains a current address based on the address information from the decoder 28e.

Next, in step S537, the CPU 40 refers to the zone information stored in the data area of the flash memory 39, and determines whether the write position is the division position “r” where the recording speed is changed. In this embodiment, because the area B is included in the both first and second zones, the recording speed needs to be changed until the recording of the user data is completed. If the write position is located at the inner periphery side relative to the division position “r”, the answer is NO in step S537, and the recording process control operation returns to step S533. Until the write position coincides with the division position “r” (that is, until the recording of the user data on the part of the area B included in the first zone of the optical disk 15 is completed), the loop process of steps S533 through S537 is repeated. If the write position coincides with the division position “r” in step S537, the recording process control operation proceeds to step S539.

In step S539, the CPU 40 intermits the recording operation. Particularly, the CPU 40 stores information with regard to the final write position where the user data is written on the area B included in the first zone immediately before, in the RAM 41 as intermittence information.

Next, in step S541, the CPU 40 sets another recording speed (i.e., the recording speed V2). Then, in step S543, the CPU 40 refers to the OPC result storage area, and determines whether OPC data obtained at the set recording speed exists. Because OPC data at the set recording speed V2 has been stored in the second OPC result storage area, the answer in step S543 becomes YES, and the recording process control operation proceeds to step S551.

Subsequently, in step S551, the CPU 40 obtains the timer value of the timer. If the OPC operation is performed in step S515 before recording user data on the part of the area B included in the first zone, the CPU 40 obtains the timer value of the timer which is counted from when the CPU 40 starts the timer in step S519 and to when the CPU 40 obtains the timer value of the timer in step S551. If the OPC operation is not performed before recording user data on the part of the area B included in the first zone, the CPU 40 obtains the timer value of the timer which is counted from when the CPU 40 starts the timer in step S525 and to when the CPU 40 obtains the timer value of the timer in step S551.

Next, in step S553, the CPU 40 determines whether the timer value obtained in step S551 is less than the predetermined value “Tim”. If the timer value obtained in step S551 is less than the value “Tim”, the CPU 40 determines that the OPC data stored in the second OPC result storage area is adequate for recording user data with the optimum recording power obtained in step S515 in the recording process control operation performed when recording the user data on the area C. Then, after the timer value of the timer is reset to “0”, the CPU 40 starts the timer in step S555.

In contrast, if the timer value obtained in step S551 is greater than or equal to the value “Tim”, the CPU 40 determines that the OPC data stored in the second OPC result storage area is inadequate. Accordingly, an optimum recording power is obtained by performing an OPC operation again at the set recording speed (i.e., the recording speed V2) in step S545.

Next, in step S547, the CPU 40 stores the optimum recording power obtained in the OPC operation in step S545 as OPC data in the second OPC result storage area of the RAM 41. Thus, the OPC data stored in the second OPC result storage area of the RAM 41 is updated. Subsequently, in step S549, after the timer value of the timer is reset to “0”, the CPU 40 starts the timer.

Next, in step S557, the CPU 40 restarts the recording operation. Particularly, the CPU 40 detects a write start position based on the intermittence information to restart recording the user data successively from the final write position. Then, the recording process control operation returns to step S533.

Until the recording of the user data on the area B is completed, the loop process of steps S533 through S537 is repeated. Here, because the recording speed is not changed until the recording of the user data on the area B is completed, the answer becomes always NO in step S537.

After the recording of the user data on the area B is completed (i.e., the answer is YES in step S533), the CPU 40 stops the timer in step S559. After the predetermined process is performed, the recording process control operation ends.

As described above, by employing the CPU 40 and by executing the program with the CPU 40, the optical disk apparatus 20 of the present embodiment provides a determining mechanism and a recording power obtaining mechanism. Specifically, the determining mechanism is achieved by executing recording process control operation steps S511 and S523 in FIG. 3A and S537 and S553 in FIG. 3B. Further, the recording power obtaining mechanism is achieved by executing recording process control operation steps S515 in FIG. 3A and S545 in FIG. 3B. Further, a recording mechanism is provided by employing the optical pickup device 23, the laser control circuit 24, the encoder 25, and the CPU 40 and by executing the program with the CPU 40. Nevertheless, the present invention is not limited to these embodiments. For example, at least part of or the entirety of the above-described mechanisms provided by executing the steps of the program with the CPU 40 may be provided in the form of hardware.

According to the above-described embodiments of the present invention, the track (i.e., the recording area) of the optical disk 15 is divided into the first zone and the second zone. A recording speed is each set by zone. Upon receiving a recording request command from the host, a zone in which an area to be recorded with user data is provided is specified. When the specified zone is the first zone, the recording speed V1 is set as a recording speed. When the specified zone is the second zone, the recording speed V2 is set as a recording speed. If the recording speed set this time is different from the recording speed set last time, it is determined whether the OPC data (i.e., the optimum recording power) corresponding to the recording speed set this time is stored in the RAM 41. If such OPC data is stored in the RAM 41 and if a time elapsed since the performance of the last OPC operation is greater than or equal to the allowable time “Tim”, the OPC data is determined to be inadequate. Then, an optimum recording power is obtained by performing an OPC operation again at the recording speed set this time, so that the OPC data relating to the optimum recording power stored in the RAM 41 is updated. By doing so, even if the light-emitting characteristic of the semiconductor laser LD changes during a period of recording user data on the recording area of the optical disk 15 at a different recording speed, an optimum recording power is updated, and user data is recorded with the updated optimum recording power. As a result, a recording operation can be performed stably by minimizing or avoiding the deterioration of recording quality.

According to the above-described embodiments of the present invention, the CPU 40 compares the this time recording speed information storage area to the last time recording speed information storage area, and determines whether the recording speed is changed in step S511 of FIG. 3A. Alternatively, if the recording speed is different by zone, the CPU 40 may determine whether the zone including the recording area to be recorded is changed in step S511 of FIG. 3A. In this case, in place of the last time recording speed information storage area and the this time recording speed information storage area, the RAM 41 may include the last time zone information storage area and this time zone information storage area. The zone information may be information which can specify or differentiate zone such as a flag, other than the zone name itself.

In the above-described embodiments of the present invention, if it is clear that the light-emitting characteristic of the semiconductor laser LD easily varies and if it is not necessary for considering the recording performance, when the answer in step S511 of FIG. 3A becomes YES, the recording process control operation may proceed to step S515 irrespective of the determination result in step S513. Further, in FIG. 3B, when the answer in step S537 of FIG. 3B becomes YES, the recording process control operation may proceed from step S541 to step S545 irrespective of the determination result in step S561. That is, the recording process control operation steps S513, S519, S521, S523, and S525 in FIG. 3A, and the recording process control operation steps S543, S549, S551, S553, and S555 in FIG. 3B may be omitted.

Further, in the above-described recording process control operation of the present embodiments, the determination in step S511 of FIG. 3A becomes affirmative when the recording speed is changed. Alternatively, the determination in step S511 of FIG. 3A may become affirmative when this time recording speed is lower than last time recording speed. Further, the determination in step S537 of FIG. 3B becomes affirmative when the write position coincides with the division position “r”. Alternatively, the determination in step S537 of FIG. 3B may become affirmative when this time recording speed is higher than last time recording speed at the division position “r”.

In the above-described embodiments, the PCA at the inner periphery side is used when performing the OPC operation at the recording speed S1, and the PCA at the outer periphery side is used when performing the OPC operation at the recording speed S2. Alternatively, the PCA at the inner periphery side may be used when performing the OPC operation at the recording speed S2, and the PCA at the outer periphery side may be used when performing the OPC operation at the recording speed S1.

Further, in the above-described embodiments, the CPU 40 determines whether the OPC data is adequate based on the time elapsed since the performance of the last OPC operation. Alternatively, the CPU 40 may determine whether the OPC data is adequate based on a physical quantity (hereafter may be referred to as “laser temperature information”) relating to a temperature in the vicinity of the semiconductor laser LD. In this case, as a non-limiting example, as shown in FIG. 7, a temperature sensor 70 acting as a temperature detecting device may be disposed in the vicinity of the semiconductor laser LD, and the output signal of the temperature sensor 70 may be supplied to the CPU 40 via the I/V amplifier 28a and an analog-to-digital (AD) converter (not shown). In this embodiment, the physical quantity relating to a temperature includes not only temperature, but also a temperature difference between the temperature in the vicinity of the semiconductor laser LD and a predetermined reference temperature, a physical quantity which can be converted to a temperature or a temperature difference, and a physical quantity which changes according to the change of temperature.

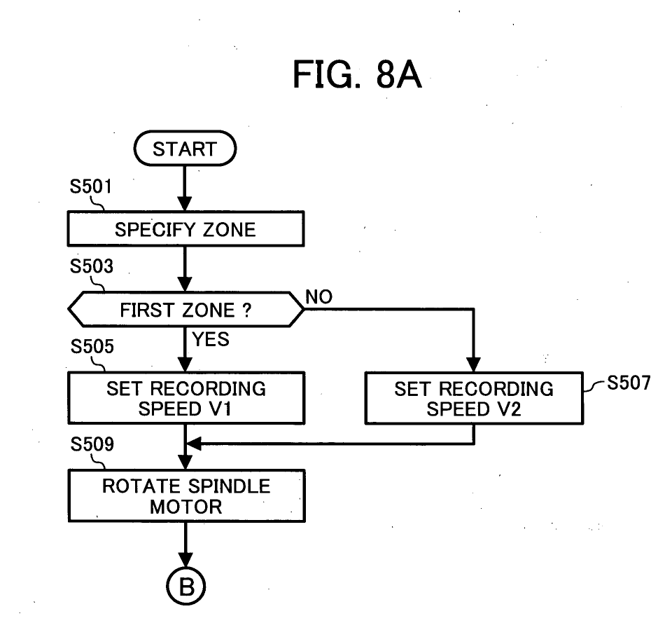

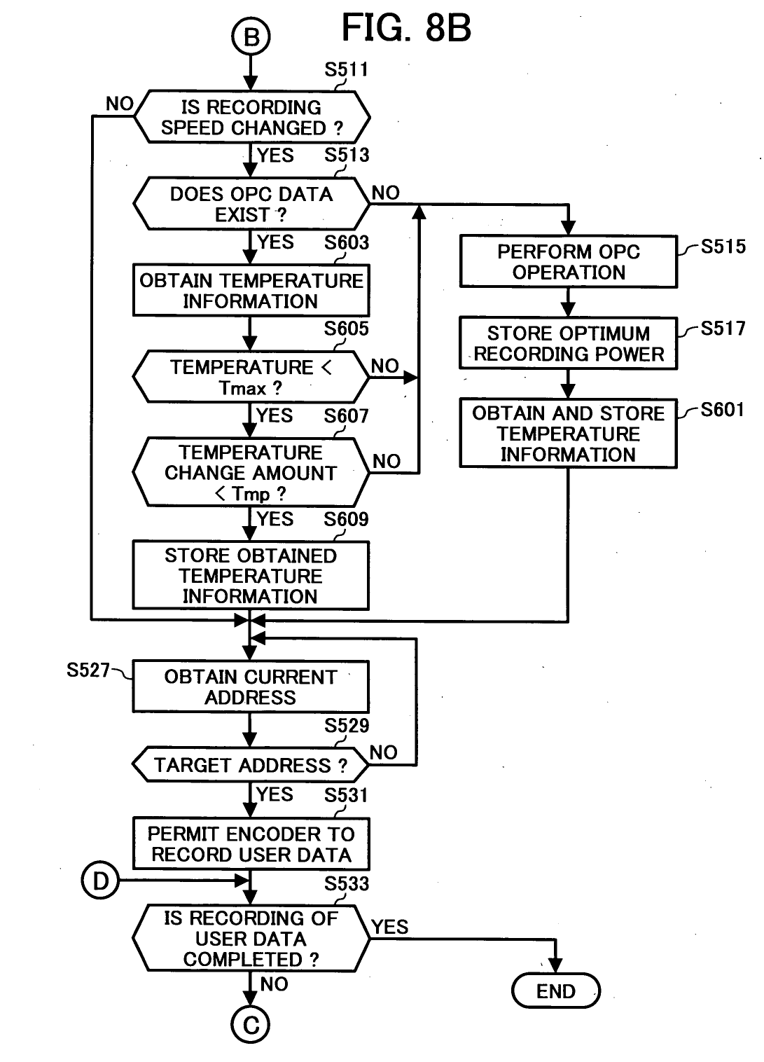

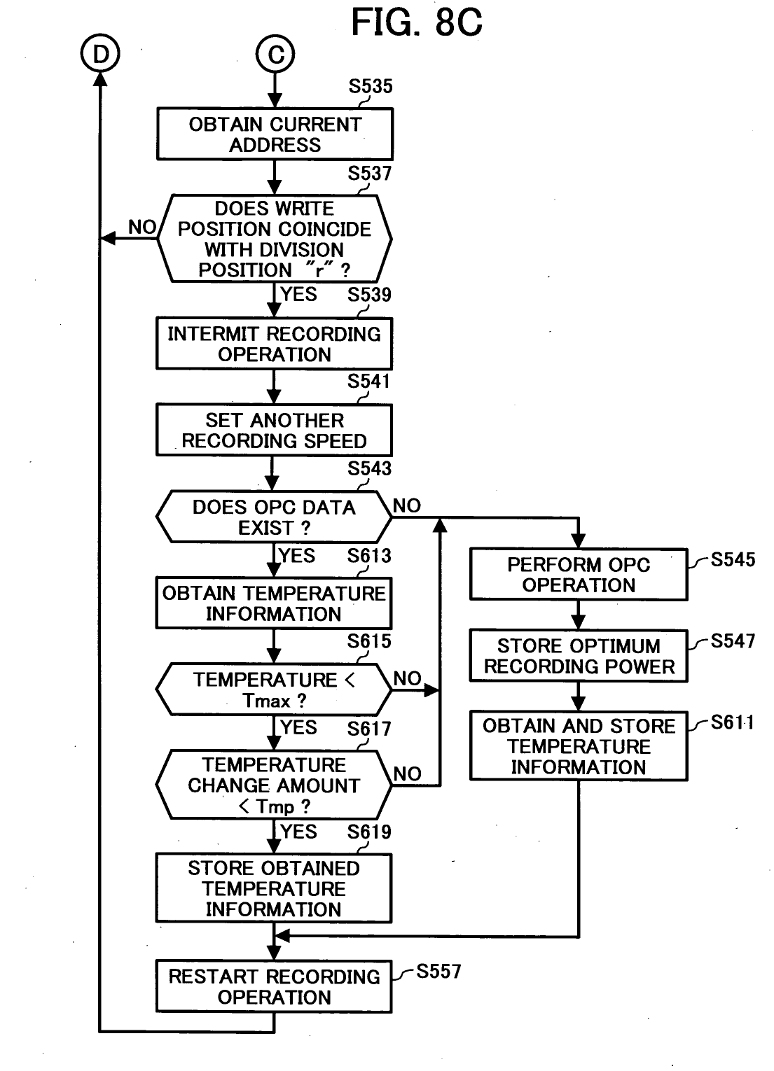

In this embodiment, the CPU 40 performs recording process control operation steps shown in FIGS. 8A, 8B, and 8C. The recording process control operation steps in FIGS. 8A, 8B, and 8C performed similarly as those in FIGS. 3A and 3B are designated with the same step numbers, and their description is simplified or omitted. Further, the RAM 41 includes a laser temperature information storage area where laser temperature information obtained when obtaining OPC data is stored.

Referring to FIGS. 8A and 8B, the recording process control operation steps S501 through S517 are performed similarly as shown in the flowchart of FIG. 3A. In step S601, the CPU 40 obtains laser temperature information based on an output signal of the temperature sensor 70, and stores the laser temperature information in the laser temperature information storage area of the RAM 41. Particularly, the information relating to the temperature in the vicinity of the semiconductor laser LD which is measured by the temperature sensor 70 when obtaining OPC data is stored in the laser temperature information storage area of the RAM 41.

In step S603, the CPU 40 obtains the laser temperature information based on the output signal of the temperature sensor 70. Next, in step S605, the CPU 40 determines whether the measured temperature is less than a predetermined upper limit value Tmax (for example, 50 degrees). If the answer is NO in step S605, the recording process control operation proceeds to step S515. Particularly, the CPU 40 determines that the OPC data stored in the first OPC result storage area is inadequate. If the answer is YES in step S605, the recording process control operation proceeds to step S607.

In step S607, the CPU 40 calculates a difference (hereafter may be referred to as a “temperature change amount”) between the temperature measured in step S603 and the temperature stored in the laser temperature information storage area of the RAM 41 when obtaining the OPC data last time (i.e., when obtaining the OPC data in the area C). Further, the CPU 40 determines whether the calculated temperature change amount is less than a predetermined allowable value Tmp (for example, 5 degrees) in step S607. If the answer is YES in step S607, the recording process control operation proceeds to step S609. Particularly, the CPU 40 determines that the OPC data stored in the first OPC result storage area is adequate. In contrast, if the answer is NO in step S607, the CPU 40 determines that the OPC data stored in the first OPC result storage area is inadequate, and an optimum recording power is obtained by performing an OPC operation again at the set recording speed in step S515.

In step S609, the CPU 40 stores the laser temperature information obtained in step S603 in the laser temperature information storage area of the RAM 41. Particularly, the CPU 40 stores the temperature measured by the temperature sensor 70 in step S603 in the laser temperature information storage area of the RAM 41. Then, the recording process control operation proceeds to step S525.

Referring to FIG. 8C, in step S611, the CPU 40 obtains laser temperature information based on an output signal of the temperature sensor 70, and stores the laser temperature information in the laser temperature information storage area of the RAM 41. Particularly, the information with regard to the temperature in the vicinity of the semiconductor laser LD which is measured by the temperature sensor 70 when performing the OPC operation is stored in the laser temperature information storage area of the RAM 41.

In step S613, the CPU 40 obtains the laser temperature information based on the output signal of the temperature sensor 70. Next, in step S615, the CPU 40 determines whether the measured temperature is less than the upper limit value Tmax. If the answer is NO in step S615, the recording process control operation proceeds to step S563. Particularly, the CPU 40 determines that the OPC data stored in the second OPC result storage area is inadequate. If the answer is YES in step S615, the recording process control operation proceeds to step S617.

In step S617, the CPU 40 calculates a temperature change amount. If the OPC operation is performed in step S515 before recording user data on the part of the area B included in the first zone, the CPU 40 calculates a temperature change amount between the temperature measured in step S613 and the temperature stored in the laser temperature information storage area of the RAM 41 in step S601. If the OPC operation is not performed before recording user data on the part of the area B included in the first zone, the CPU 40 calculates a temperature change amount between the temperature measured in step S613 and the temperature stored in the laser temperature information storage area of the RAM 41 in step S609.

Further, the CPU 40 determines whether the calculated temperature change amount is less than the predetermined allowable value Tmp in step S617. If the answer is YES in step S617, the recording process control operation proceeds to step S619. Particularly, the CPU 40 determines that the OPC data stored in the second OPC result storage area is adequate. In contrast, if the answer is NO in step S617, the CPU 40 determines that the OPC data stored in the second OPC result storage area is inadequate, and an optimum recording power is obtained by performing an OPC operation again at the set recording speed in step S563.

In step S619, the CPU 40 stores the laser temperature information obtained in step S613 in the laser temperature information storage area of the RAM 41. Particularly, the CPU 40 stores the temperature measured by the temperature sensor 70 in step S613 in the laser temperature information storage area of the RAM 41. Then, the recording process control operation proceeds to step S573.

With the above-described recording process control operation of FIGS. 8A, 8B, and 8C, the similar effect as in the recording process control operation of FIGS. 3A and 3B can be achieved.

In the above-described recording process control operation steps in FIGS. 8A, 8B, and 8C, if it is clear that the temperature measured in step S603 is less than the upper limit value Tmax, the recording process control operation step S605 may be omitted, and the recording process control operation may directly proceed to step S607 from step S603. Further, if it is clear that the temperature measured in step S613 is less than the upper limit value Tmax, the recording process control operation step S615 may be omitted, and the recording process control operation may directly proceed to step S617 from step S613.

The present invention has been described with respect to the exemplary embodiment illustrated in the figures. However, the present invention is not limited to this embodiment and may be practiced otherwise.

In the above-described embodiments, the computer program is stored in the flash memory 39. Alternatively, the computer program may be stored in other recording media such as a compact disk (CD), an optical magnetic disk, a digital versatile disk (DVD), a memory card, a universal serial bus (USB) memory, and a flexible disk. In the case of storing the computer program in such other recording media, the computer program may be loaded to the flash memory 39 via a reproduction device or an interface which corresponds to each of the recording media. Further, the computer program may be transferred to the flash memory 39 via a network such as a local-area network (LAN), an intranet, and the Internet. Any other method may be employed so long as the computer program can be loaded to the flash memory 39.

Although the present embodiment has been described on the assumption that the optical disk apparatus 20 is adapted to optical disks in conformity with a DVD+R standard, the optical disk apparatus 20 may be adapted to optical disks on which information can be recorded by the ZCLV system.

In the above-described embodiment, the optical disk apparatus 20 is configured to record and reproduce information data on and from the optical disk 15. However, the optical disk apparatus 20 may be able to perform at least an information recording operation among the information recording operation, an information reproducing operation, and an information erasing operation.

Although the optical pickup device 23 of the present embodiment includes a single semiconductor laser, plural semiconductor lasers that emit laser light beams with different wavelengths may also be employed. For example, the plural semiconductor lasers may include at least one of a semiconductor laser that emits a laser light beam with a wavelength of about 405 nm, a semiconductor laser that emits a laser light beam with a wavelength of about 660 nm, and a semiconductor laser that emits a laser light beam with a wavelength of about 780 nm. That is, the optical disk apparatus 20 may be adapted to plural kinds of optical disks each conforming to the standards different with one another. The plural kinds of optical disks may include at least an optical disk on which information data can be recorded by the ZCLV system.

Numerous additional modifications and variations of the present invention are possible in light of the above teachings. It is therefore understood that within the scope of the appended claims, the present invention may be practiced other than as specifically described herein.

1. A method of recording information by emitting a laser light beam from a light source to an optical disk which includes a recording area divided into a plurality of zones where information is recorded at predetermined recording speeds, respectively, the plurality of zones including a first zone on which information is recorded with a predetermined recording power of a laser light beam at a recording speed set corresponding to the first zone, and a second zone on which information is recorded with a predetermined recording power of a laser light beam at a recording speed set corresponding to the second zone, the method comprising steps of:
obtaining an optimum recording power of a laser light beam emitted when recording information on the first zone at the recording speed set corresponding to the first zone;
obtaining an optimum recording power of a laser light beam emitted when recording information on the second zone at the recording speed set corresponding to the second zone;
determining whether the optimum recording power of the laser light beam emitted when recording information on the first zone is adequate for use in recording information on a this time recording area provided in the first zone based on the recording speed set corresponding to the first zone and the recording speed set corresponding to the second zone when a last recording area is provided in the second zone; and
obtaining updated optimum recording power of the laser light beam emitted when recording information on the first zone when the optimum recording power of the laser light beam emitted when recording information on the first zone is determined to be not adequate.

2. The method according to claim 1,
wherein the determining step comprises determining that the optimum recording power of the laser light beam emitted when recording information on the first zone is not adequate, when the recording speed set corresponding to the first zone and the recording speed set corresponding to the second zone are different from each other.

3. The method according to claim 2,
wherein the determining step comprises determining that the optimum recording power of the laser light beam emitted when recording information on the first zone is not adequate, when the recording speed set corresponding to the first zone is lower than the recording speed set corresponding to the second zone.

4. The method according to claim 1,
wherein the determining step comprises determining whether the optimum recording power of the laser light beam emitted when recording information on the first zone is adequate based on at least one of a time elapsed since the optimum recording power of the laser light beam emitted when recording information on the second zone at the recording speed set corresponding to the second zone is obtained, and a physical quantity relating to a temperature in a vicinity of the light source.

5. The method according to claim 4,
wherein the determining step comprises determining that the optimum recording power of the laser light beam emitted when recording information on the first zone is not adequate, when the recording speed set corresponding to the first zone and the recording speed set corresponding to the second zone are different from each other, and when the time is greater than or equal to a predetermined allowable time.

6. The method according to claim 4,
wherein the determining step comprises determining that the optimum recording power of the laser light beam emitted when recording information on the first zone is not adequate, when the recording speed set corresponding to the first zone and the recording speed set corresponding to the second zone are different from each other, and when an amount of the physical quantity changed from a physical quantity detected when the optimum recording power of the laser light beam emitted when recording information on the second zone at the recording speed set corresponding to the second zone is obtained, is greater than or equal to a predetermined allowable value.

7. The method according to claim 4,
wherein the determining step comprises determining that the optimum recording power of the laser light beam emitted when recording information on the first zone is not adequate, when the recording speed set corresponding to the first zone and the recording speed set corresponding to the second zone are different from each other, and when the physical quantity is greater than or equal to a predetermined upper limit value.

8. A computer program comprising program code means that, when executed by a controller of an optical disk apparatus, instructs the apparatus to carry out a method of recording information by emitting a laser light beam from a light source to an optical disk which includes a recording area divided into a plurality of zones where information is recorded at predetermined recording speeds, respectively, the plurality of zones including a first zone on which information is recorded with a predetermined recording power of a laser light beam at a recording speed set corresponding to the first zone, and a second zone on which information is recorded with a predetermined recording power of a laser light beam at a recording speed set corresponding to the second zone, the method comprising steps of:
obtaining an optimum recording power of a laser light beam emitted when recording information on the first zone at the recording speed set corresponding to the first zone;
obtaining an optimum recording power of a laser light beam emitted when recording information on the second zone at the recording speed set corresponding to the second zone;
determining whether the optimum recording power of the laser light beam emitted when recording information on the first zone is adequate for use in recording information on a this time recording area provided in the first zone based on the recording speed set corresponding to the first zone and the recording speed set corresponding to the second zone when a last recording area is provided in the second zone; and
obtaining updated optimum recording power of the laser light beam emitted when recording information on the first zone when the optimum recording power of the laser light beam emitted when recording information on the first zone is determined to be not adequate.

9. The program according to claim 8,
wherein the determining step comprises determining that the optimum recording power of the laser light beam emitted when recording information on the first zone is not adequate, when the recording speed set corresponding to the first zone and the recording speed set corresponding to the second zone are different from each other.

10. The program according to claim 9,
wherein the determining step comprises determining that the optimum recording power of the laser light beam emitted when recording information on the first zone is not adequate, when the recording speed set corresponding to the first zone is lower than the recording speed set corresponding to the second zone.

11. The program according to claim 8,
wherein the determining step comprises determining whether the optimum recording power of the laser light beam emitted when recording information on the first zone is adequate based on at least one of a time elapsed since the optimum recording power of the laser light beam emitted when recording information on the second zone at the recording speed set corresponding to the second zone is obtained, and a physical quantity relating to a temperature in a vicinity of the light source.

12. The program according to claim 11,
wherein the determining step comprises determining that the optimum recording power of the laser light beam emitted when recording information on the first zone is not adequate, when the recording speed set corresponding to the first zone and the recording speed set corresponding to the second zone are different from each other, and when the time is greater than or equal to a predetermined allowable time.

13. The program according to claim 11,
wherein the determining step comprises determining that the optimum recording power of the laser light beam emitted when recording information on the first zone is not adequate, when the recording speed set corresponding to the first zone and the recording speed set corresponding to the second zone are different from each other, and when an amount of the physical quantity changed from a physical quantity detected when the optimum recording power of the laser light beam emitted when recording information on the second zone at the recording speed set corresponding to the second zone is obtained, is greater than or equal to a predetermined allowable value.

14. The program according to claim 11,
wherein the determining step comprises determining that the optimum recording power of the laser light beam emitted when recording information on the first zone is not adequate, when the recording speed set corresponding to the first zone and the recording speed set corresponding to the second zone are different from each other, and when the physical quantity is greater than or equal to a predetermined upper limit value.

15. A computer readable storage medium storing a computer program comprising program code means that, when executed by a controller of an optical disk apparatus, instructs the apparatus to carry out a method of recording information by emitting a laser light beam from a light source to an optical disk which includes a recording area divided into a plurality of zones where information is recorded at predetermined recording speeds, respectively, the plurality of zones including a first zone on which information is recorded with a predetermined recording power of a laser light beam at a recording speed set corresponding to the first zone, and a second zone on which information is recorded with a predetermined recording power of a laser light beam at a recording speed set corresponding to the second zone, the method comprising steps of:
obtaining an optimum recording power of a laser light beam emitted when recording information on the first zone at the recording speed set corresponding to the first zone;
obtaining an optimum recording power of a laser light beam emitted when recording information on the second zone at the recording speed set corresponding to the second zone;
determining whether the optimum recording power of the laser light beam emitted when recording information on the first zone is adequate for use in recording information on a this time recording area provided in the first zone based on the recording speed set corresponding to the first zone and the recording speed set corresponding to the second zone when a last recording area is provided in the second zone; and
obtaining updated optimum recording power of the laser light beam emitted when recording information on the first zone when the optimum recording power of the laser light beam emitted when recording information on the first zone is determined to be not adequate.

16. The medium according to claim 15,
wherein the determining step comprises determining that the optimum recording power of the laser light beam emitted when recording information on the first zone is not adequate, when the recording speed set corresponding to the first zone and the recording speed set corresponding to the second zone are different from each other.

17. The medium according to claim 16,
wherein the determining step comprises determining that the optimum recording power of the laser light beam emitted when recording information on the first zone is not adequate, when the recording speed set corresponding to the first zone is lower than the recording speed set corresponding to the second zone.

18. The medium according to claim 15,
wherein the determining step comprises determining whether the optimum recording power of the laser light beam emitted when recording information on the first zone is adequate based on at least one of a time elapsed since the optimum recording power of the laser light beam emitted when recording information on the second zone at the recording speed set corresponding to the second zone is obtained, and a physical quantity relating to a temperature in a vicinity of the light source.

19. The medium according to claim 18,
wherein the determining step comprises determining that the optimum recording power of the laser light beam emitted when recording information on the first zone is not adequate, when the recording speed set corresponding to the first zone and the recording speed set corresponding to the second zone are different from each other, and when the time is greater than or equal to a predetermined allowable time.

20. The medium according to claim 18,
wherein the determining step comprises determining that the optimum recording power of the laser light beam emitted when recording information on the first zone is not adequate, when the recording speed set corresponding to the first zone and the recording speed set corresponding to the second zone are different from each other, and when an amount of the physical quantity changed from a physical quantity detected when the optimum recording power of the laser light beam emitted when recording information on the second zone at the recording speed set corresponding to the second zone is obtained, is greater than or equal to a predetermined allowable value.

21. The medium according to claim 18,
wherein the determining step comprises determining that the optimum recording power of the laser light beam emitted when recording information on the first zone is not adequate, when the recording speed set corresponding to the first zone and the recording speed set corresponding to the second zone are different from each other, and when the physical quantity is greater than or equal to a predetermined upper limit value.

22. An optical disk apparatus that performs at least an information recording operation among the information recording operation, an information reproducing operation, and an information erasing operation, the optical disk apparatus comprising:
a light source configured to emit a laser light beam to an optical disk which includes a recording area divided into a plurality of zones where information is recorded at predetermined recording speeds, respectively, wherein the plurality of zones include a first zone on which information is recorded with a predetermined recording power of a laser light beam at a recording speed set corresponding to the first zone, and a second zone on which information is recorded with a predetermined recording power of a laser light beam at a recording speed set corresponding to the second zone;
a recording power obtaining mechanism configured to obtain an optimum recording power of a laser light beam emitted when recording information on the first zone at the recording speed set corresponding to the first zone, and to obtain an optimum recording power of a laser light beam emitted when recording information on the second zone at the recording speed set corresponding to the second zone;
a determining mechanism configured to determine whether the optimum recording power of the laser light beam emitted when recording information on the first zone, which has been obtained by the recording power obtaining mechanism, is adequate for use in recording information on a this time recording area provided in the first zone based on the recording speed set corresponding to the first zone and the recording speed set corresponding to the second zone when a last recording area is provided in the second zone, wherein when the determining mechanism determines that the optimum recording power of the laser light beam emitted when recording information on the first zone is not adequate, the recording power obtaining mechanism is configured to obtain updated optimum recording power of the laser light beam emitted when recording information on the first zone; and
a recording mechanism configured to record information on the first zone with the updated optimum recording power obtained by the recording power obtaining mechanism.

23. The optical disk apparatus according to claim 22,
wherein the determining mechanism is configured to determine that the optimum recording power of the laser light beam emitted when recording information on the first zone is not adequate, when the recording speed set corresponding to the first zone and the recording speed set corresponding to the second zone are different from each other.

24. The optical disk apparatus according to claim 23,
wherein the determining mechanism is configured to determine that the optimum recording power of the laser light beam emitted when recording information on the first zone is not adequate, when the recording speed set corresponding to the first zone is lower than the recording speed set corresponding to the second zone.

25. The optical disk apparatus according to claim 22,
wherein the determining mechanism is configured to determine whether the optimum recording power of the laser light beam emitted when recording information on the first zone is adequate based on a time elapsed since the recording power obtaining mechanism obtains the optimum recording power of the laser light beam emitted when recording information on the second zone at the recording speed set corresponding to the second zone.

26. The optical disk apparatus according to claim 25,
wherein the determining mechanism is configured to determine that the optimum recording power of the laser light beam emitted when recording information on the first zone is not adequate, when the recording speed set corresponding to the first zone and the recording speed set corresponding to the second zone are different from each other, and when the time is greater than or equal to a predetermined allowable time.

27. The optical disk apparatus according to claim 22, further comprising:
a detecting device configured to detect a physical quantity relating to a temperature in a vicinity of the light source,
wherein the determining mechanism is configured to determine whether the optimum recording power of the laser light beam emitted when recording information on the first zone is adequate based on the physical quantity detected by the detecting mechanism.

28. The optical disk apparatus according to claim 27,
wherein the determining mechanism is configured to determine that the optimum recording power of the laser light beam emitted when recording information on the first zone is not adequate, when the recording speed set corresponding to the first zone and the recording speed set corresponding to the second zone are different from each other, and when an amount of the physical quantity changed from a physical quantity detected when the recording power obtaining mechanism obtains the optimum recording power of the laser light beam emitted when recording information on the second zone at the recording speed set corresponding to the second zone is greater than or equal to a predetermined allowable value.

29. The optical disk apparatus according to claim 27,
wherein the determining mechanism is configured to determine that the optimum recording power of the laser light beam emitted when recording information on the first zone is not adequate, when the recording speed set corresponding to the first zone and the recording speed set corresponding to the second zone are different from each other, and when the physical quantity is greater than or equal to a predetermined upper limit value.
